(19) United States
(12) Patent Application Publication
(10) Pub. No.: US 2023/0121481 A1
(43) Pub. Date: Apr. 20, 2023

(54) HYBRID SOLID ELECTROLYTE SHEET AND METHOD OF MANUFACTURING THE SAME

(71) Applicants: Hyundai Motor Company, Seoul (KR); Kia Corporation, Seoul (KR); Ulsan National Institute of Science and Technology, Ulsan (KR)

(72) Inventors: Soon Chul Byun, Yongin (KR); Sang Mo Kim, Hwaseong (KR); Yong Seok Choi, Seoul (KR); Jae Min Lim, Suwon (KR); Hoon Seok, Suwon (KR); Sang Young Lee, Seoul (KR); Yong Hyeok Lee, Seoul (KR); Yi Su Jeong, Sejong (KR)

(21) Appl. No.: 17/967,749

(22) Filed: Oct. 17, 2022

(30) Foreign Application Priority Data
Oct. 19, 2021 (KR) 10-2021-0139154

(51) Int. Cl. H01M 10/056; H01M 10/052

(52) U.S. Cl. CPC H01M 10/056; H01M 10/052; H01M 2300/0091; H01M 2300/0082; H01M 2300/008; H01M 2300/0085

(57) ABSTRACT

Disclosed are a hybrid solid electrolyte sheet and a method of manufacturing the same. The hybrid solid electrolyte sheet includes a hybrid solid electrolyte layer including a gel polymer electrolyte, thereby securing flexibility and alleviating brittleness. In addition, the hybrid solid electrolyte sheet includes a porous polymer film having a plurality of pores, thus minimizing the content of the acrylate monomer in the pores thereof and providing advantages of maintaining the continuity of the solid electrolyte while minimizing a decrease in ionic conductivity.

### CROSS-REFERENCE TO RELATED APPLICATION

This application claims under 35 U.S.C. § 119(a) the benefit of priority to Korean Patent Application No. 10-2021-0139154, filed on Oct. 19, 2021, the entire contents of which are incorporated herein by reference.

### TECHNICAL FIELD

The present invention relates to a solid electrolyte sheet including a porous polymer film and a hybrid solid electrolyte layer, and a method of manufacturing the same.

### BACKGROUND

As the demand for electric vehicles and large-capacity power storage devices increases, various batteries capable of satisfying the demand have been developed.

Particularly, lithium secondary batteries, which exhibit the best energy density and output characteristics, have been widely commercialized. In particular, lithium secondary batteries including a liquid electrolyte containing an organic solvent (hereinafter referred to as “liquid-type secondary batteries”) have mainly been used.

However, liquid-type secondary batteries in which the liquid electrolyte is decomposed during the electrode reaction may cause the battery to expand and increasing the risk of ignition due to leakage of the liquid electrolyte. Lithium secondary batteries using a solid electrolyte (hereinafter referred to as “all-solid-state batteries”) having excellent stability are attracting a great deal of attention as an approach to solve the problems with liquid-type secondary batteries.

Meanwhile, solid electrolytes may be categorized into oxide-based and sulfide-based electrolytes. Sulfide-based solid electrolytes have been more commonly used as solid electrolytes because sulfide-based solid electrolytes have high lithium ionic conductivity and are stable over a wide voltage range compared to oxide-based solid electrolytes.

However, sulfide-based solid electrolytes may have a low Young's modulus and thus exhibit high ionic conductivity even at a low manufacturing pressure, but have a problem in that they should be produced with a increased thickness due to the brittleness thereof.

The above information disclosed in this Background section is only for enhancement of understanding of the background of the invention, and therefore it may contain information that does not form the prior art that is already known in this country to a person of ordinary skill in the art.

### SUMMARY

In preferred aspects, provided is a solid electrolyte sheet including a porous polymer film including a plurality of pores and a hybrid solid electrolyte layer disposed on at least one surface of the porous polymer film, and a method of manufacturing the same. The hybrid solid electrolyte layer may include a solid electrolyte and a gel polymer electrolyte.

A term “solid electrolyte sheet” as used herein refers to a solid electrolyte formed in a film (e.g., thin film) or a sheet having planar structure. Preferably, the solid electrolyte sheet is made of a supporting layer (e.g., polymer film) and electrolyte material embedded or impregnated therein. For example, the solid electrolyte sheet may be formed of a porous polymeric sheet or film and electrolyte material (e.g., ionomers or ionic liquid) embedded or impregnated in the film.

The objects of the present invention are not limited to those described above. Other objects of the present invention will be clearly understood from the following description, and are able to be implemented by means defined in the claims and combinations thereof.

In one aspect, provided is a solid electrolyte sheet including a porous polymer film including a plurality of pores, and a hybrid solid electrolyte layer disposed on at least one surface of the porous polymer film. Preferably, the hybrid solid electrolyte layer may include a solid electrolyte and a gel polymer electrolyte.

The porous polymer film may include a nonwoven fabric.

The solid electrolyte may include a sulfide-based solid electrolyte.

The gel polymer electrolyte may include a polymer including an acrylate repeating unit and an ionic sorbate liquid.

The gel polymer electrolyte may include the polymer in an amount of about 3.5% by weight or less based on the total weight of the gel polymer electrolyte.

The gel polymer electrolyte may include the polymer in an amount of about 1.5% by weight or less based on the total weight of the hybrid solid electrolyte layer.

The acrylate repeating unit may include one or more selected from the group consisting of ethoxylated trimethylolpropane triacrylate (ETPTA), trimethylolpropane triacrylate (TMPTA), and poly(ethylene glycol) diacrylate (PEGDA).

The ionic sorbate liquid may include a lithium salt and a glyme.

The lithium salt may include one or more selected from the group consisting of LiSCN, LiN(CN)₂, LiClO₄, LiBF₄, LiAsF₆, LiPF₆, LiCF₃SO₃, Li(FSO₂)₂N, Li(CF₃SO₂)₃C, LiN(SO₂CF₃)₂, LiN(SO₂CF₂CF₃)₂, LiSbF₆, LiPF₃(CF₂CF₃)₃, LiPF₃(C₂F₅)₃, LiPF₃(CF₃)₃, and LiB(C₂O₄)₂. The glyme may include one or more selected from group consisting of monoglyme, diglyme, triglyme, and tetraglyme.

The hybrid solid electrolyte layer may have a thickness of about 20 μm to 120 μm. The hybrid solid electrolyte layer may have electrical conductivity of about 5.2×10⁻⁴ S/cm or more at room temperature.

In another aspect, provided is a method of manufacturing a solid electrolyte sheet. The method may include providing a porous polymer film, applying a hybrid solid electrolyte mixture onto at least one surface of the porous polymer film, crosslinking the applied hybrid solid electrolyte mixture, and compressing the crosslinked hybrid solid electrolyte mixture and the porous polymer film.

The hybrid solid electrolyte mixture may include a solid electrolyte and a gel polymer electrolyte precursor.

The hybrid solid electrolyte mixture may suitably include an amount of about 50% to 58% by weight of the solid electrolyte and an amount of about 42% to 50% by weight of the gel polymer electrolyte precursor, based on the total weight of the hybrid solid electrolyte mixture. The gel polymer electrolyte precursor may include an acrylate monomer and an ionic sorbate liquid.

The acrylate monomer may include one or more selected from the group consisting of ethoxylated trimethylolpropane triacrylate (ETPTA), poly(ethylene glycol) diacrylate (PEGDA), and 1,6-hexanediol diacrylate (HDDA).

The ionic sorbate liquid may suitably include a lithium salt and a glyme.

Also provided is an all-solid-state battery including the solid electrolyte sheet as described herein.

Other aspects of the invention are discussed infra.

### BRIEF DESCRIPTION OF THE DRAWINGS

The above and other features of the present invention will now be described in detail with reference to certain exemplary embodiments thereof, illustrated in the accompanying drawings which are given hereinbelow by way of illustration only, and thus are not limitative of the present invention, and wherein:

FIG. 1 shows a graph showing the ionic conductivity of hybrid solid electrolyte sheets in Example 1 according to an exemplary embodiment of the present invention, Comparative Example 2, and Comparative Example 3.

### DETAILED DESCRIPTION

The objects described above, as well as other objects, features, and advantages, will be clearly understood from the following preferred embodiments with reference to the attached drawings. However, the present invention is not limited to the embodiments, and may be embodied in different forms. The embodiments are suggested only to offer a thorough and complete understanding of the disclosed context and to sufficiently inform those skilled in the art of the technical concept of the present invention.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a “first” element may be referred to as a “second” element, and similarly, a “second” element may be referred to as a “first” element. Singular forms are intended to include plural forms as well, unless the context clearly indicates otherwise.

It will be further understood that terms such as “comprise” or “has”, when used in this specification, specify the presence of stated features, integers, steps, operations, elements, components, or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, FIGURES, and/or expressions that represent ingredients, reaction conditions, polymer compositions, and amounts of mixtures used in the specification are approximations that reflect various uncertainties of measurement occurring inherently in obtaining these FIGURES, among other things. For this reason, it should be understood that, in all cases, the term “about” should be understood to modify all such numbers, FIGURES and/or expressions. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numerical ranges are disclosed in the description, these ranges are continuous, and include all numbers from the minimum to the maximum, including the maximum within each range, unless otherwise defined. Furthermore, when a range refers to an integer, it includes all integers from the minimum to the maximum, including the maximum within the range, unless otherwise defined.

It should be understood that, in the specification, when a range is referred to regarding a parameter, the parameter encompasses all FIGURES including end points disclosed within the range. For example, the range of “5 to 10” includes FIGS. of 5, 6, 7, 8, 9, and 10, as well as arbitrary sub-ranges, such as ranges of 6 to 10, 7 to 10, 6 to 9, and 7 to 9, and any FIGS., such as 5.5, 6.5, 7.5, 5.5 to 8.5, and 6.5 to 9, between appropriate integers that fall within the range. In addition, for example, the range of “10% to 30%” encompasses all integers that include numbers such as 10%, 11%, 12%, and 13%, as well as 30%, and any sub-ranges, such as 10% to 15%, 12% to 18%, or 20% to 30%, as well as any numbers, such as 10.5%, 15.5%, and 25.5%, between appropriate integers that fall within the range.

Provided herein is a hybrid solid electrolyte sheet including a porous polymer film including a plurality of pores and a hybrid solid electrolyte layer including a solid electrolyte and a gel polymer electrolyte. The hybrid solid electrolyte sheet may have secured flexibility and less brittleness using appropriately controlled contents of the solid electrolyte and the gel polymer electrolyte and appropriately controlled contents of the polymer and ionic liquid in the gel polymer electrolyte. As such, the continuity of the solid electrolyte can be maintained and the decrease in ionic conductivity can be minimized by minimizing the content of monomer constituting the polymer.

In an aspect, a solid electrolyte sheet includes a porous polymer film including a plurality of pores and a hybrid solid electrolyte layer disposed on at least one surface of the porous polymer film. The hybrid solid electrolyte layer may include a solid electrolyte and a gel polymer electrolyte.

The porous polymer film may include a plurality of pores that sufficiently and appropriately contains the acrylate monomer used in the manufacturing method, including, for example, at least one selected from the group consisting of a nonwoven fabric, a porous separator, and a synthetic separator. Preferably, the porous polymer film may be a nonwoven fabric, which is suitable for use as a support due to the excellent physical properties thereof and large pores therein.

The material used for the porous polymer film may include a conventional material that can be used to manufacture the solid electrolyte sheet in the present invention, for example, at least one selected from the group consisting of polyethylene terephthalate (PET), polybutylene terephthalate (PBT), polyamide (PA), polyurethane (PU), viscose rayon, low-density polyethylene (LDPE), high-density polyethylene (HDPE), medium-density polyethylene (MDPE), linear low-density polyethylene (LLDPE), polypropylene (PP), polystyrene (PS), polyvinyl chloride (PVC), and polyacrylate, but there is no limitation as to the type of the material used for the porous polymer film.

The size of the pores in the porous polymer film may be about 2 μm to 150 μm, particularly, about 3 μm to 30 μm. When the size of the pores is less than the predetermined size, e.g., less than about 2 μm, it is difficult to impregnate the film with the solid electrolyte, and when the size of the pores is greater than the predetermined size, e.g., greater than about 150 μm, there is a disadvantage in that the impregnation of the solid electrolyte is non-uniform.

The hybrid solid electrolyte layer may be disposed on at least one surface of the porous polymer film, preferably on both surfaces of the porous polymer film, in order to improve the flexibility and continuity of the solid electrolyte.

The thickness of the hybrid solid electrolyte layer may be about 20 μm to 120 μm, particularly about 20 μm to 50 μm. When the thickness of the hybrid solid electrolyte layer is less than the predetermined thickness, e.g., less than about 20 μm, there is a high possibility of a short circuit, and when the thickness of the hybrid solid electrolyte layer is greater than the predetermined thickness, e.g., greater than about 50 μm, resistance increases, disadvantageously deteriorating output characteristics.

The hybrid solid electrolyte layer may include a solid electrolyte and a gel polymer electrolyte in respectively appropriate amounts.

The solid electrolyte is a conventional sulfide-based solid electrolyte, may include a sulfide-based solid electrolyte according to Formula 1 below.

LₐM_{b}P_{c}S_{d}Xₑ [Formula 1]

wherein L includes at least one element selected from the group consisting of alkali metals, M includes at least one element selected from the group consisting of B, Al, Ga, In, Si, Ge, Sn, Pb, As, Sb, Bi, Ti, V, Mn, Fe, Co, Ni, Cu, Y, Zr, Nb, Mo, Tc, Ru, Rh, Pd, Ag, Hf, Ta, and W, X includes at least one element selected from the group consisting of F, Cl, Br, I and O, 0≤a≤12, 0≤b≤6, 0≤c≤6, 0≤d≤12, and 0≤e≤9.

More preferably, the solid electrolyte may suitably include at least one selected from the group consisting of Li₆PS₅Cl, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ(wherein m and n are positive numbers, and Z is one of Ge, Zn and Ga), Li₂S—GeS₂, Li₂S—SiS₂—Li₃PO₄, Li₂S—SiS₂-LiₓMO_{y} (wherein x and y are positive numbers, and M is one of P, Si, Ge, B, Al, Ga, and In), and Li₁₀GeP₂S₁₂. There is no limitation as to the type of the material for the solid electrolyte.

Accordingly, the content of the solid electrolyte may be an amount of about 95% by weight or less, particularly an amount of about 40 to 60% by weight, based on 100% by weight of the entire hybrid solid electrolyte layer. When the content of the solid electrolyte is less than the predetermined content, e.g., less than about 40% by weight, the continuity of the solid electrolyte is low, and when the content of the solid electrolyte is greater than the predetermined content, e.g., greater than about 95% by weight, a slurry cannot be obtained, which is disadvantageous for casting.

The gel polymer electrolyte may contain a polymer including an acrylate repeating unit and an ionic sorbate liquid.

When a polymer including an acrylate repeating unit is used as the polymer, high yield is obtained due to good crosslinking reactivity. Particularly, the polymer including the acrylate repeating unit may include at least one polymer selected from the group consisting of triacrylate including ethoxylated trimethylolpropane triacrylate (ETPTA) or trimethylolpropane triacrylate (TMPTA), and di-acrylate including poly(ethylene glycol) diacrylate (PEGDA).

Accordingly, the content of the polymer according to an embodiment may be an amount of about 10% by weight or less, particularly an amount of about 3.5 to 10% by weight, based on the total weight of the gel polymer electrolyte. Particularly, the content of the polymer may be an amount of about 5% by weight or less, and more particularly, an amount of about 1.5% by weight to 5% by weight, based on the total weight of the hybrid solid electrolyte layer. When the content of the polymer is less than the predetermined content, e.g., less than about 1.5% by weight crosslinking does not occur, and when the content of the polymer is excessively high, resistance increases.

The ionic sorbate liquid may suitably include a lithium salt and a glyme.

The lithium salt may include a lithium salt commonly used in lithium secondary batteries, for example, at least one salt selected from the group consisting of LiSCN, LiN(CN)₂, LiClO₄, LiBF₄, LiAsF₆, LiPF₆, LiCF₃SO₃, Li(FSO₂)₂N, Li(CF₃SO₂)₃C, LiN(SO₂CF₃)₂, LiN(SO₂CF₂CF₃)₂, LiSbF₆, LiPF₃(CF₂CF₃)₃, LiPF₃(C₂F₅)₃, LiPF₃(CF₃)₃, and LiB(C₂O₄)₂.

The glyme may be a material that contains oxygen and is thus capable of coordinating lithium salts, for example, at least one selected from monoglyme, diglyme, triglyme, and tetraglyme. Particularly, the triglyme may suitably include triethylene glycol dimethyl ether and the tetraglyme may be tetraethylene glycol dimethyl ether. For example, when the glyme contains 4 or 5 oxygen molecules and is thus coordinated with lithium, it is advantageously capable of forming a coordination compound having excellent stability.

The polymer including the acrylate repeating unit contains oxygen and thus enables lithium to be coordinated such that movement of lithium ions in the electrolyte may be hindered.

However, the ionic sorbate liquid may coordinate lithium of the lithium salt to oxygen of the glyme while the remaining salts of the lithium salt independently exist, so the mobility of lithium ions can be improved. As such, phenomenon in which the movement of lithium is hindered due to the formation of excessively many coordination bonds between the acrylate repeating unit and lithium ions may be effectively prevented compared to when the gel polymer electrolyte does not contain the ionic sorbate liquid.

Particularly, the content ratio (molar ratio) of the lithium salt to the glyme may be about 1:0.5 to 1:1.5. When the content of the glyme is less than the predetermined ratio, e.g., less than about 0.5 molar ratio to the content the lithium salt, that is, below the above range, the lithium salt is not dissolved due to the high content thereof and ionic conductivity decreases due to the high viscosity, and thus ionic conductivity is lowered. When the content of the glyme is greater than the predetermined ratio, e.g., greater than about 1.5 molar ratio to the content the lithium salt, there is a disadvantage in that the unbonded oxygen atoms in the glyme react with the sulfide solid electrolyte.

Accordingly, the hybrid solid electrolyte sheet may not be broken even after 200 cycles of a 180-degree bending test at a speed of about 10 degrees/sec and a radius of curvature of about 15 mm using a specimen with a size of about 2×5 cm², and thus advantageously exhibits high flexibility and electrical conductivity of about 5.2×10⁻⁴ S/cm.

That is, the hybrid solid electrolyte sheet may include a hybrid solid electrolyte layer including a gel polymer electrolyte in an appropriate amount, and thus may be imparted with flexibility and alleviate brittleness, which is a property of conventional solid electrolytes. Also, the hybrid solid electrolyte sheet may minimize the number of the repeating units of the acrylate monomers and thus may minimize the decrease in ionic conductivity while maintaining the continuity of the solid electrolyte.

In another aspect, the present invention also provides a method of manufacturing a hybrid solid electrolyte sheet including providing a porous polymer film, applying a hybrid solid electrolyte mixture onto at least one surface of the porous polymer film, crosslinking the applied hybrid solid electrolyte mixture, and compressing the crosslinked hybrid solid electrolyte mixture and the porous polymer film.

The method of manufacturing the hybrid solid electrolyte sheet may include content substantially overlapping the content related to the hybrid solid electrolyte sheet described above, and a description of redundant content may be omitted.

The hybrid solid electrolyte mixture may suitably include a solid electrolyte and a gel polymer electrolyte precursor, and the components contained in the gel polymer electrolyte precursor are the same as components contained in the hybrid solid electrolyte layer, except that the gel polymer electrolyte precursor includes an uncrosslinked acrylate monomer. For example, the acrylate monomer may include at least one polymer selected from the group consisting of ethoxylated trimethylolpropane triacrylate (ETPTA), poly(ethylene glycol) diacrylate (PEGDA), and 1,6-hexanediol diacrylate (HDDA).

The hybrid solid electrolyte mixture may suitably include an amount of about 50% to 58% by weight of the solid electrolyte and an amount of about 42% to 50% by weight of the gel polymer electrolyte precursor based on the total weight of the hybrid solid electrolyte mixture. When the content of the solid electrolyte is less than about 50% by weight and the content of the gel polymer electrolyte precursor is greater than about 50% by weight, the continuity of the solid electrolyte is lowered and the physical properties thereof are deteriorated. On the other hand, when the content of the gel polymer electrolyte precursor is less than about 42% by weight and the content of the solid electrolyte is greater than about 58% by weight, there are problems in which a slurry is not formed and uniform casting is impossible.

Accordingly, application of the hybrid solid electrolyte mixture may be performed using a conventional method, for example, tape casting, which enables uniform application over a large area in an inexpensive and simple manner to improve processability.

The crosslinking may be performed by crosslinking the acrylate monomer contained in the hybrid solid electrolyte mixture applied to the porous polymer film to polymerize the polymer including the acrylate repeating unit.

However, when the hybrid solid electrolyte layer is disposed on two surfaces of the porous polymer film, the solid electrolyte mixture may be applied to one surface thereof and perform crosslinking, and then the solid electrolyte mixture may be applied to the other surface and perform crosslinking.

Particularly, the crosslinking may be performed by emitting ultraviolet rays under conditions of irradiation at an intensity of about 5,000 mW cm′ for about 1 to 3 minutes.

The compression includes compressing an initial hybrid solid electrolyte sheet including the porous polymer film and the hybrid solid electrolyte layer including the gel polymer electrolyte containing the polymer including the acrylate repeating unit, obtained by polymerization using crosslinking, to form a final hybrid solid electrolyte sheet.

For example, the compression may be performed using a conventional compression method of manufacturing a solid electrolyte sheet, for example, roll-to-roll compression, surface compression, or warm isostatic pressing (WIP). In this case, the compression may be surface compression using a pelletizer.

### Example

Hereinafter, the present invention will be described in more detail with reference to specific examples. However, the following examples are provided only for better understanding of the present invention, and thus should not be construed as limiting the scope of the present invention.

### Example 1: Production of Hybrid Solid Electrolyte Sheet

As a porous polymer film, a nonwoven fabric having an average pore size of 110 μm (unit) was prepared using a polymer nonwoven fabric as a material.

In addition, a hybrid solid electrolyte mixture containing a solid electrolyte and a gel polymer electrolyte precursor was prepared as follows.

First, Li₆PS₅Cl was prepared as the solid electrolyte. In addition, the gel polymer electrolyte precursor was prepared by mixing an acrylate monomer with a lithium salt and a glyme as ingredients for an ionic sorbate liquid. The acrylate monomer used herein was ETPTA, the lithium salt used herein was LiTFSI, and the glyme used herein was triglyme.

At this time, the hybrid solid electrolyte mixture contained 58% by weight of the solid electrolyte and 42% by weight of the gel polymer electrolyte precursor based on the total weight of the hybrid solid electrolyte mixture, and the polymer was present in an amount of 3.5% by weight based on the total weight of the gel polymer electrolyte.

Then, the hybrid solid electrolyte mixture was applied onto one surface of the prepared porous polymer film using tape casting, crosslinking was performed thereon to crosslink and polymerize the acrylate monomer, the hybrid solid electrolyte mixture was applied to the other surface of the porous polymer film using tape casing in the same manner as above, and crosslinking was then performed thereon to crosslink and polymerize the acrylate monomer to produce an initial hybrid solid electrolyte sheet.

At this time, crosslinking was performed by exposing the resulting structure to ultraviolet rays with an intensity of 5,000 mW cm′ for 1 to 3 minutes.

Then, compression was performed by surface compression at 78 MPa to produce a hybrid solid electrolyte sheet containing 1.5% by weight of the polymer based on the total weight of the hybrid solid electrolyte layer.

### Comparative Example 1: Production of Hybrid Solid Electrolyte Sheet

A hybrid solid electrolyte sheet containing 6.0% by weight of the polymer based on the total weight of the hybrid solid electrolyte layer was produced in the same manner as in Example 1, except that the polymer was present in an amount of 15% by weight based on the total weight of the gel polymer electrolyte.

### Comparative Example 2: Production of Hybrid Solid Electrolyte Sheet

A hybrid solid electrolyte sheet containing 4.2% by weight of the polymer based on the total weight of the hybrid solid electrolyte layer was produced in the same manner as in Example 1, except that the polymer was present in an amount of 10% by weight based on the total weight of the gel polymer electrolyte.

### Comparative Example 3: Production of Hybrid Solid Electrolyte Sheet

A hybrid solid electrolyte sheet containing 2.1% by weight of the polymer based on the total weight of the hybrid solid electrolyte layer was produced in the same manner as in Example 1, except that the polymer was present in an amount of 5% by weight based on the total weight of the gel polymer electrolyte.

Experimental Example 1: Evaluation of Flexibility of Hybrid Solid Electrolyte Sheet

Hybrid solid electrolyte sheets were produced in Example 1 and Comparative Examples 1 to 3, and specimens with a size of 2×5 cm² obtained therefrom were subjected to a 180° bending test with a radius of curvature of 15 mm at a speed of 10 degrees/sec.

As a result, the resulting values of the bending test showed that the hybrid solid electrolyte sheet according to Example 1 broke after only 200 cycles, and the hybrid solid electrolyte sheets according to Comparative Examples 1 to 3 broke before 200 cycles.

That is, the hybrid solid electrolyte sheet according to an exemplary embodiment secured flexibility and alleviates brittleness.

Experimental Example 2: Evaluation of Ionic Conductivity of Hybrid Solid Electrolyte Sheet

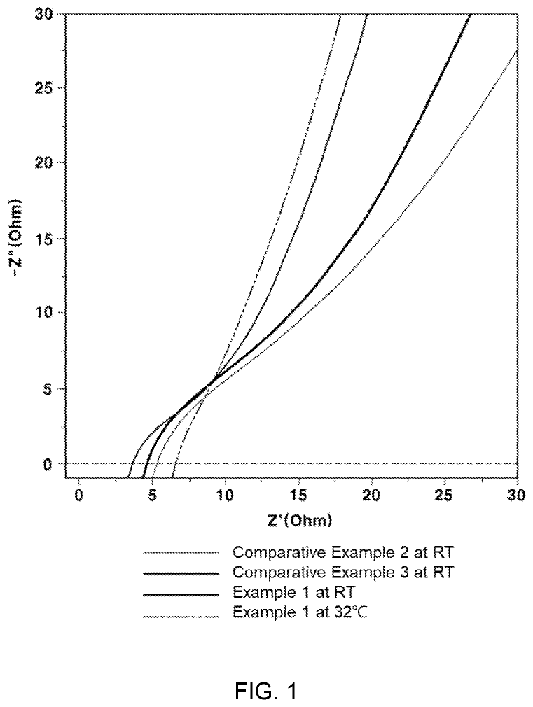

Hybrid solid electrolyte sheets were produced in Example 1 and Comparative Examples 1 to 3, ionic conductivity was evaluated based on impedance, and the results are shown in Table 1 and FIG. 1 below.

TABLE 1

| | | | | | | | Measurement |
|---|---|---|---|---|---|---|---|
| | | Thickness (um) | | | Ionic | Ionic | conditions |
| | Polymer | Before | After | Resistance | conductance | conductivity | (press, |
| Item | content | pelletizing | pelletizing | (Ohm) | (S) | (S/cm) | temperature) |
| Comparative | 15 | ~105 | ~76 | 31.3 | 3.19 × 10⁻² | 1.83 × 10⁻⁴ | 1 ton, at RT |
| Example 1 | | | | | | | |
| Comparative | 10 | ~121 | ~85 | 26.33 | 3.80 × 10⁻² | 2.43 × 10⁻⁴ | |
| Example 2 | | | | | | | |
| Comparative | 5 | ~94 | ~77 | 21.68 | 4.61 × 10⁻² | 2.68 × 10⁻⁴ | |
| Example 3 | | | | | | | |
| Example 1 | 3.5 | ~116 | ~76 | 10.97 | 9.12 × 10⁻² | 5.22 × 10⁻⁴ | |
| Example 1 | 3.5 | ~116 | ~76 | 7.90 | 1.27 × 10⁻¹ | 7.25 × 10⁻⁴ | 1 ton, at 32° C. |

FIG. 1 shows the ionic conductivity of hybrid solid electrolyte sheets in Example 1, Comparative Example 2, and Comparative Example 3. As can be seen from Table 1 and FIG. 1, the increase in ionic conductivity of the solid electrolyte sheets in Comparative Examples 1 to 3 was small, whereas the ionic conductivity of the hybrid solid electrolyte sheet according to Example 1 was remarkably increased compared to the ionic conductivity according to Comparative Example 3.

That is, the hybrid solid electrolyte sheet according to an exemplary embodiment had the advantage of minimizing a decrease in ionic conductivity while maintaining the continuity of the solid electrolyte because the content of the acrylate monomer could be minimized.

As will be apparent from the foregoing, the hybrid solid electrolyte sheet according to various exemplary embodiments of the present invention includes the hybrid solid electrolyte layer containing the gel polymer electrolyte, thereby securing flexibility and alleviating brittleness. In addition, the hybrid solid electrolyte sheet according to various exemplary embodiments of the present invention includes the porous polymer film including a plurality of pores, thus minimizing the content of the acrylate monomer in the pores thereof and providing advantages of maintaining the continuity of the solid electrolyte while minimizing a decrease in ionic conductivity.

The effects of the present invention are not limited to those mentioned above. It should be understood that the effects of the present invention include all effects that can be inferred from the description of the present invention.

The present invention has been described in detail with reference to embodiments thereof. However, it will be appreciated by those skilled in the art that changes may be made in these embodiments without departing from the principles and spirit of the present invention, the scope of which is defined in the appended claims and their equivalents.

What is claimed is:

1. A solid electrolyte sheet comprising:
a porous polymer film comprising a plurality of pores; and
a hybrid solid electrolyte layer disposed on at least one surface of the porous polymer film,
wherein the hybrid solid electrolyte layer comprises a solid electrolyte and a gel polymer electrolyte.

2. The solid electrolyte sheet according to claim 1, wherein the porous polymer film comprises a nonwoven fabric.

3. The solid electrolyte sheet according to claim 1, wherein the solid electrolyte comprises a sulfide-based solid electrolyte.

4. The solid electrolyte sheet according to claim 1, wherein the gel polymer electrolyte comprises a polymer comprising an acrylate repeating unit and an ionic sorbate liquid.

5. The solid electrolyte sheet according to claim 4, wherein the gel polymer electrolyte comprises in an amount of about 3.5% by weight or less based on the total weight of the gel polymer electrolyte.

6. The solid electrolyte sheet according to claim 4, wherein the gel polymer electrolyte comprises the polymer in an amount of about 1.5% by weight or less based on the total weight of the hybrid solid electrolyte layer.

7. The solid electrolyte sheet according to claim 4, wherein the acrylate repeating unit comprises one or more selected from the group consisting of ethoxylated trimethylolpropane triacrylate (ETPTA), trimethylolpropane triacrylate (TMPTA), and poly(ethylene glycol) diacrylate (PEGDA).

8. The solid electrolyte sheet according to claim 4, wherein the ionic sorbate liquid comprises a lithium salt and a glyme.

9. The solid electrolyte sheet according to claim 8, wherein the lithium salt comprises one or more selected from the group consisting of LiSCN, LiN(CN)₂, LiClO₄, LiBF₄, LiAsF₆, LiPF₆, LiCF₃SO₃, Li(FSO₂)₂N, Li(CF₃SO₂)₃C, LiN(SO₂CF₃)₂, LiN(SO₂CF₂CF₃)₂, LiSbF₆, LiPF₃(CF₂CF₃)₃, LiPF₃(C₂F₅)₃, LiPF₃(CF₃)₃, and LiB(C₂O₄)₂.

10. The solid electrolyte sheet according to claim 8, wherein the glyme comprises one or more selected from the group consisting of monoglyme, diglyme, triglyme, and tetraglyme.

11. The solid electrolyte sheet according to claim 1, wherein the hybrid solid electrolyte layer has a thickness of about 20 μm to 120 μm.

12. The solid electrolyte sheet according to claim 1, wherein the hybrid solid electrolyte layer has electrical conductivity of about 5.2×10⁻⁴ S/cm or greater at room temperature.

13. A method of manufacturing a hybrid solid electrolyte sheet, comprising:
providing a porous polymer film;
applying a hybrid solid electrolyte mixture onto at least one surface of the porous polymer film;
crosslinking the hybrid solid electrolyte mixture; and
compressing the crosslinked hybrid solid electrolyte mixture and the porous polymer film.

14. The method according to claim 13, wherein the hybrid solid electrolyte mixture comprises a solid electrolyte and a gel polymer electrolyte precursor.

15. The method according to claim 13, wherein the hybrid solid electrolyte mixture comprises an amount of about 50% to 58% by weight of the solid electrolyte and an amount of about 42% to 50% by weight of the gel polymer electrolyte precursor based on the total weight of the hybrid solid electrolyte mixture.

16. The method according to claim 13, wherein the gel polymer electrolyte precursor comprises an acrylate monomer and an ionic sorbate liquid.

17. The method according to claim 16, wherein the acrylate monomer comprises one or more selected from the group consisting of ethoxylated trimethylolpropane triacrylate (ETPTA), poly(ethylene glycol) diacrylate (PEGDA), and 1,6-hexanediol diacrylate (HDDA).

18. The method according to claim 16, wherein the ionic sorbate liquid comprises a lithium salt and a glyme.

19. An all-solid-state battery comprising a solid electrolyte sheet of claim 1.
